(19) United States
(12) Patent Application Publication
(10) Pub. No.: US 2003/0173025 A1
(43) Pub. Date: Sep. 18, 2003

(54) Method for decorative crystals

(76) Inventor: Kathrine Baumann, West Hollywood, CA (US)

Correspondence Address: Charles T.J. Weigell, Bryan Cave LLP, 245 Park Avenue, New York, NY, 10167-0034, US

(21) Appl. No.: 10/098,215

(22) Filed: Mar. 14, 2002

(51) Int. Cl. B32B 31/00; B65C 1/00

(52) U.S. Cl. 156/297

(57) ABSTRACT

A method of crystal adornment of a surface involves providing a surface, applying adhesive to the surface, applying a crystal of a first size to the surface; applying a crystal of a second size to the surface approximately adjacent to the crystal of the first size, wherein the second size differs from the first size, applying a crystal of a third size to the surface approximately adjacent to one of the crystal of the first size and the crystal of the second size, and covering at least a portion of the surface by continuing to apply a plurality of crystals of either the first size, the second size and the third size such that only crystals of different sizes are adjacent to one another.

### FIELD OF THE INVENTION

The invention relates to decorative and ornamental devices.

### BACKGROUND OF THE INVENTION

Use of crystal adornment for various products including personal articles, articles of wear, and for bags, purses, and cases is well known. Placing the crystals in a regimented pattern or applying crystals of uniform size is the common and favored decorative technique, though the results of such regimentation and uniformity of the crystals so applied may detract from the artistic and aesthetic impression of the object so decorated. Slight misapplications and differences in crystal size in otherwise uniform patterns also tends to mar presentation and becomes a clear contrast to the overall effect of the pattern. What is needed is a method to yield an arrangement of crystals that brings forth an aesthetically pleasing and engaging decorative design while avoiding a tediously over-regimented effect.

### BRIEF DESCRIPTION OF THE DRAWINGS

FIG. 1 shows a crystal placement scheme including large size crystals according to the preferred embodiment of the invention.

FIG. 2 shows a crystal placement scheme including smaller size crystals according to the preferred embodiment of the invention.

### SUMMARY OF THE INVENTION

A method of crystal adornment is disclosed comprising the steps of providing a surface, applying adhesive to the surface, applying a crystal of a first size to the surface; applying a crystal of a second size to the surface approximately adjacent to the crystal of the first size, wherein the second size differs from the first size, applying a crystal of a third size to the surface approximately adjacent to one of the crystal of the first size and the crystal of the second size, and covering at least a portion of the surface by continuing to apply a plurality of crystals of either the first size, the second size and the third size such that only crystals of different sizes are adjacent to one another.

Also disclosed is a method of crystal adornment comprising the steps of providing a surface, applying adhesive to the surface, applying a crystal of a first color to the surface, applying a crystal of a second color to the surface approximately adjacent to the crystal of the first color, wherein the second color differs from the first color, applying a crystal of a third color to the surface approximately adjacent to one of the crystal of the first color and the crystal of the second color, covering at least a portion of the surface by continuing to apply a plurality of crystals of either the first color, the second color, and the third color such that only crystals of different colors are adjacent to one another.

### DETAILED DESCRIPTION OF THE INVENTION

The invention will be described with respect to the figures. The figures each illustrate crystal exemplary crystal arrangements wherein crystals are applied to a surface according to the method of the preferred embodiment of the invention. The invention relates to a method of applying the crystals to a surface so as to create distinctive crystal arrangements for clothing, purses, minaudiere, and bags, among many other useful, fashionable and decorative items.

The first step in the method is to select a surface to be adorned. The particular surface can be one of a multitude of potential surfaces involving metals, precious metals, fabric, canvas, hard or soft polymer based surfaces, leather or other materials. Preferably, the material surface used is a precious metal surface, such as titanium-24k gold plated surface, but also use of fabric and leather surfaces such as cloth, clothing, shoes and other wearables are also within the scope and contemplation of the invention. These materials are selected for various reasons including maximizing aesthetic appeal, and ability to hold the adhesive used to apply the crystals and may be, in the case of metals, sufficiently rigid to inhibit bending or folding that could produce cracking or spaces between the crystals as applied thereto.

Once the surface material is selected, a suitable adhesive is applied, for instance, an epoxy based type adhesive or other adhesive known to the trade, to at least a portion of the surface on which the crystals are to be applied. The adhesive may be applied in various ways known to the trade, such as spraying, coating by brush or roller, or dipping/immersion of the article to be adorned. Preferably, the adhesive is an epoxy adhesive, from Devcon of Danvers, Mass. Multi-purpose cement or glue such as 527 Cement or Elmer's Brand Glue may also be used.

Once the adhesive is applied, crystals of varying size may then be applied in a specific manner, as will be further described, yielding an arrangement that gives the impression of random placement. The crystals used may be made of glass. Preferably, the crystals are made of glass, colored by certain minerals, and are known as Swarovski(tm) Crystals provided by, for instance, D. Swarovski G Co., of Wattens, Austria. Crystals are preferably semi-spherical in shape, but use of spherical crystals or crystals in other shapes are also within the scope and contemplation of the invention.

Typically, crystals, and especially Swarovski Crystals, are offered in standard diametric sizes identified by numeric value pertaining to a particular diametric size. For instance, available sizes include 16 (approximately 3.8 mm) down to 5 (approximately 1.6 mm), with intermediate sizes including 12 (approximately 3.0 mm), 9 (approximately 2.4 mm), 7 (approximately 2.1 mm), 5 (approximately 1.6 mm). Preferably, crystals of the same color, tone or color scheme are used for each adornment. Alternatively, for instance, where a particular representative design, i.e. a cat face, is sought to be applied, or simply to provide a different look, arrangements of different color crystals can be used. This may include, for instance in a fashion reminiscent of a mosaic, whereby each collections of different colored crystals occupying separate areas create the overall design

Application of the crystals to the adhesive portion of the article to be adorned is preferably done by a suitable applicator such as tweezers. Other applicators, or manners of applying the crystals, may also be used. Preferably, the crystals are applied one by one in a manner defined by the size of the surrounding crystals, whereby application of the crystals is intentionally varied by size, not allowing any crystals of the same size to be contiguous and avoiding placement in an incremental linear or circumferential succession of increasing or decreasing sizes where possible. This involves applying a crystal of a first size to the surface, then applying a crystal of a second size to the surface approximately adjacent to the crystal of the first size, wherein the second size differs from the first size, then applying a crystal of a third size to the surface approximately adjacent to one of the crystal of the first size and the crystal of the second size. The method then involves covering at least a portion of the surface by continuing to apply a plurality of crystals of either the first size, the second size or the third size such that only crystals of different sizes are adjacent to one another.

Similarly, in other embodiments, more than three sizes of crystals may be used. Taking the method described in the foregoing paragraph, this further involves applying a crystal of a fourth size to the surface approximately adjacent to one of the crystal of the first size, the crystal of the third size and the crystal of the second size, then covering at least a portion of the surface by continuing to apply a plurality of crystals of either the first size, the second size, the third size and the fourth size such that only crystals of different sizes are applied adjacent to one another. For a fifth size crystal, this further involves applying a crystal of a fifth size to the surface approximately adjacent to one of the crystal of the first size, the second size, the third size and the crystal of the fourth size, then covering at least a portion of the surface by continuing to apply a plurality of crystals of either the first size, the second size, the third size and the fourth size such that only crystals of different sizes are applied adjacent to one another.

It must be pointed out that the application method imposes a lack of uniformity or regimentation in sizes, including any uniformity or regimentation that may inevitably result through a completely haphazard or random application of crystals on a surface. Without applying the crystals in a deliberate fashion to maintain their dissimilar arrangement and differences in sizes, avoiding juxtaposing or associating crystals of similar size, or placing them according to a uniformly circumferential or linear increase or decrease in crystal sizes, it is likely that with repeated applications, certain unintended patters of similar size or uniform size progression, whether circumferential or linear, will likely occur, thus detracting from the overall varying arrangement of crystals intended.

In an alternative embodiment, similar or different size crystals of different colors may be applied to a surface, using the applicators and adhesives previously described, as well as others known in the art, according to the method of the preferred embodiment. For instance, where three colors of crystals are selected, a surface is provided and adhesive applied thereto. Then a crystal of a first color, for instance blue, is applied to the surface. Thereafter a crystal of a second color, for instance, green, is applied to the surface approximately adjacent to the blue crystal. Further, a crystal of a third color, for instance, red is applied to the surface approximately adjacent to one of the blue crystal or the green crystal. This is continued covering at least a portion of the surface by continuing to apply a plurality of crystals of either blue, red and green such that only crystals of different colors are adjacent to one another. Where the four crystals of different colors would be used, applying a crystal of a fourth color, for instance, silver, to the surface approximately adjacent to one of the blue red or green crystals and covering at least a portion of the surface by continuing to apply the crystals, such that only crystals of different colors are applied adjacent to one another. Where a fifth color crystal is used, for instance gold, it is applied to the surface approximately adjacent to one of the blue, red, green or silver crystals. The application is continued to cover at least a portion of the surface by applying a plurality of blue, red, green, silver, or gold crystals such that only crystals of different sizes are applied adjacent to one another. Other colors and color combinations for crystals may also occur, including shades of the same or similar colors used in such combinations.

The following examples are illustrative of the preferred embodiment of the invention.

### EXAMPLE 1

A portion of a surface to be adorned, for instance a titanium surface with a 24 karat gold plate, is coated with an adhesive. Swarovski Crystals are selected having sizes 16, 12, 9, 7 and 6. These crystals are applied, one by one, to the adhesive coated surface, varying the sizes of contiguously placed crystals. Applying two or more crystals of similar sizes adjacent to each other is to be avoided. For instance, a size 16 is first applied. Crystals of sizes 12, 9, 7 and 6 are placed about the circumference of the size 16 crystal approximately adjacent thereto, preferably not in a sequential order of placement where the crystals increase or decrease progressively in size. Therefore, for instance, crystals are applied circumferentially in clockwise fashion around the size 16 crystal starting with a size 12, then a size 6 adjacent to the size 16 and size 12, then a size 9 adjacent to the size 12 and the size 6, and then a size 7 adjacent to the size 9 and the size 16 and continuing around the circumference of the size 16.

Then, selecting one of the four crystals around the size 16 circumference portion, additional crystals are placed thereabout. For instance, selecting the size 12 crystal, which already borders a size 16 crystal and, for instance, a size 6 crystal, this size 12 crystal is then surrounded by applied adjacent crystals of sizes 16, 9, 7, and 6 whereas the sizes 16 and 9 crystals are placed either diametrically opposite the other corresponding crystals of that size already bordering the size 12 crystal, or are separated by at least one additional crystal of differing size, i.e. not a size 12, size 16 or size 9 crystal. Thus, the variety of sizes and the lack of any regimentation or pattern in the distribution of crystals is maintained. Eventually, the entire given surface of the article to be adorned may be covered.

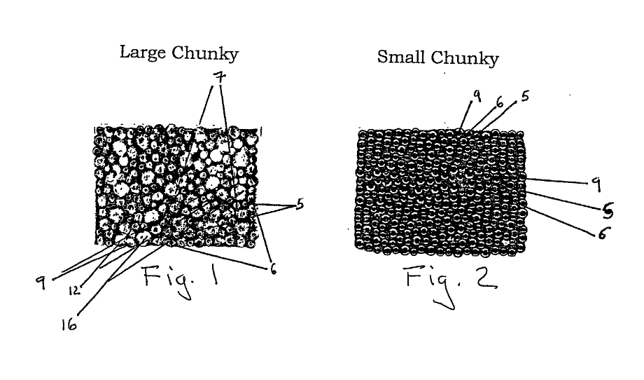

FIG. 1 illustrates an applied pattern of crystals according to the embodiment of Example 1. In this the “large chunky” style of applied crystals are apparent. Numbers appearing on the figure denote standard sizes of the Swarovski crystals included, i.e. sizes 16, 12, 9, 7 and 6.

### EXAMPLE 2

Taking the method for the crystal arrangement of Example 1, smaller size crystals, i.e. sizes 5, 7 and 9 are applied to a provided surface, or alternatively, sizes 5, 6, 7, and 9. The application of these crystals do not present as great a contrast in size as the “large chunky” embodiment of Example 1, but reveals a more subtle arrangement specifically approaching the appearance of uniform placement and/or juxtaposition, yet clearly lacking such uniformity upon close inspection. This arrangement is illustrated in FIG. 2 and is referred to as the “small chunky” style of application.

As the number of different sizes is less than five, and the sizes closer in proportionate size, placement in alternating positions involves less discretion. For instance, where three different size crystals are involved, placement of size 5 may dictate placement of a size 7 and a size 9 on either opposite side. As such, some placement of crystals in a progression of increasing or decreasing may be unavoidable, but still less uniform than if the application were completely random.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

What is claimed is:

1. A method of crystal adornment of a surface, comprising:
a) providing a surface;
b) applying adhesive to the surface;
c) applying a crystal of a first size to the surface;
d) applying a crystal of a second size to the surface approximately adjacent to the crystal of the first size, wherein the second size differs from the first size;
e) applying a crystal of a third size to the surface approximately adjacent to one of the crystal of the first size and the crystal of the second size;
f) covering at least a portion of the surface by continuing to apply a plurality of crystals of either the first size, the second size or the third size such that only crystals of different sizes are adjacent to one another.

2. The method of claim 1, wherein the smallest crystal size used is at least about 1.7 mm in diameter.

3. The method of claim 1, wherein the smallest crystal size used is at least about 1.6 mm in diameter.

4. The method of claim 1, wherein the largest crystal size used is about 3.8 mm in diameter.

5. The method of claim 1, wherein the largest crystal size used is about 2.4 mm in diameter.

6. The method of claim 1, further comp rising:
a) applying a crystal of a fourth size to the surface approximately adjacent to one of the crystal of the first size, the crystal of the third size and the crystal of the second size; and
b) covering at least a portion of the surface by continuing to apply a plurality of crystals of either the first size, the second size, the third size and the fourth size such that only crystals of different sizes are applied adjacent to one another.

7. The method of claim 6, further comprising:
a) applying a crystal of a fifth size to the surface approximately adjacent to one of the crystal of the first size, the second size, the third size and the crystal of the fourth size; and
b) covering at least a portion of the surface by continuing to apply a plurality of crystals of either the first size, the second size, the third size and the fourth size such that only crystals of different sizes are applied adjacent to one another.

8. A method of crystal adornment of a surface, comprising:
a) providing a surface;
b) applying adhesive to the surface;
c) applying a crystal of a first color to the surface;
d) applying a crystal of a second color to the surface approximately adjacent to the crystal of the first color, wherein the second color differs from the first color;
e) applying a crystal of a third color to the surface approximately adjacent to one of the crystal of the first color and the crystal of the second color;
f) covering at least a portion of the surface by continuing to apply a plurality of crystals of either the first color, the second color and the third color such that only crystals of different colors are adjacent to one another.

9. The method of claim 8, further comprising:
a) applying a crystal of a fourth color to the surface approximately adjacent to one of the crystal of the first color, the crystal of the third color and the crystal of the second color; and
b) covering at least a portion of the surface by continuing to apply a plurality of crystals of either the first color, the second color, the third color and the fourth color such that only crystals of different colors are applied adjacent to one another.

10. The method of claim 9, further comprising:
a) applying a crystal of a fifth color to the surface approximately adjacent to one of the crystal of the first color, the second color, the third color and the crystal of the fourth color; and
b) covering at least a portion of the surface by continuing to apply a plurality of crystals of either the first color, the second color, the third color and the fourth color such that only crystals of different colors are applied adjacent to one another.
